(19) United States
(12) Patent Application Publication
(10) Pub. No.: US 2023/0305510 A1
(43) Pub. Date: Sep. 28, 2023

(54) SERVO CONTROL DEVICE

(71) Applicant: FANUC CORPORATION, Yamanashi (JP)

(72) Inventors: Takashi OKAMOTO, Yamanashi (JP); Yuuki MORITA, Yamanashi (JP)

(73) Assignee: FANUC CORPORATION, YAMANASHI (JP)

(21) Appl. No.: 18/044,920

(22) PCT Filed: Oct. 6, 2021
(86) PCT No.: PCT/JP2021/037048

§ 371 Date: Mar. 10, 2023

(30) Foreign Application Priority Data
Oct. 13, 2020 (JP) 2020-172267

(51) Int. Cl. G05B 19/18

(52) U.S. Cl. CPC G05B 19/182; G05B 2219/41177

(57) ABSTRACT

The purpose of the present invention is to provide a control device that enables learning control according to the angle-synchronization method to be applied even when oscillation operation is performed in a processing machine that does not have a main shaft. According to a configuration having a phase-data-creating unit and a learning control unit that performs learning control on the basis of the phase data, learning control according to the angle synchronization method can be applied even in processing machines that do not have a main shaft. The phase-data-creating unit creates servo-control-period-specific phase data from the servo control periods of a servo control device, and data relating to periods of non-repeatable normal movement commands and repeatable oscillation commands as communicated from a higher control device.

### TECHNICAL FIELD

The present invention relates to a servo control device, particularly to a servo control device that applies learning control by angle synchronization.

### BACKGROUND ART

Learning control has been applied to machine tools controlled by a servo control device to generate a high-precision command value for an oscillation motion.

Patent Document 1 describes a control device for a machine tool that performs oscillation cutting, and the control device includes a feed shaft controller for controlling at least one feed shaft by a position command. The feed shaft controller controls the feed shaft based on a composite command obtained by adding a positional deviation and an oscillation command. The control device further includes a learning controller for performing learning control based on an oscillation phase calculated from the oscillation command and the composite command. It is also described that applying the learning control to the oscillation cutting allows accurate control in response to a cyclic operation command instructing a tool or a workpiece to relatively oscillate in a machining feed direction.

Patent Document 2 discloses a servo control device for a machine tool that includes multiple control shafts and performs an oscillation motion based on a command distributed to each shaft of the machine tool and an angle of a main shaft, and describes that the control device performs learning control of calculating an amount of oscillation correction based on an oscillation frequency component extracted from a position deviation. It is also described that this machine tool can achieve high-precision oscillation motion even at a high oscillation frequency.
Patent Document 1: Japanese Unexamined Patent Application, Publication No. 2019-28597
Patent Document 2: Japanese Unexamined Patent Application, Publication No. 2017-182336

### DISCLOSURE OF THE INVENTION

### Problems to Be Solved by the Invention

As described above, it has been known that applying the learning control to the servo control device for the machine tool that performs the oscillation motion allows high precision control. However, the learning control described in both of Patent Documents 1 and 2 is based on angle synchronization, and is achieved on the assumption that the machine tool has a main shaft and phase data can be acquired from the frequency of the main shaft. For example, when a machining device with no main shaft, such as a laser machining device with a Galvano system, performs the oscillation motion, the phase data of the main shaft cannot be obtained. Thus, it has been impossible for such a device to employ the control by the angle synchronization, i.e., the learning control described above cannot be applied to the device.

Development of a control device adopting the learning control has been required for high precision control of the oscillation motion of the machining device with no main shaft. An object of the present disclosure is to provide a control device that can apply learning control by angle synchronization to an oscillation motion of a machining device with no main shaft.

### Means for Solving the Problems

To achieve the object, the present disclosure provides a servo control device for controlling a servomotor. The servo control device includes: a phase data calculator that calculates, when receiving a repetitive oscillation command alone from a host controller, phase data per servo control cycle of the servo control device from data of a cycle or frequency of the repetitive oscillation command and the servo control cycle of the servo control device, or calculates, when receiving a superimposed command generated by superimposing the repetitive oscillation command on a non-repetitive normal move command from the host controller, phase data per servo control cycle of the servo control device from data of a cycle or frequency of the repetitive oscillation command alone in the superimposed command and the servo control cycle of the servo control device; and a learning controller that performs learning control by angle synchronization based on the phase data.

### Effects of the Invention

The servo control device of the present disclosure calculates the phase data for each servo control cycle, and performs the learning control based on the phase data. Thus, when the machining involving the oscillation motion is performed by a machining device that has no main shaft and cannot acquire the phase data directly from the frequency of the main shaft, the learning control by the angle synchronization can be applied to the device, allowing high precision control.

### BRIEF DESCRIPTION OF THE DRAWINGS

FIG. 1 is a control block diagram of a servo control device of an embodiment of the present disclosure;

FIG. 2 is a diagram illustrating a normal move command and repetitive oscillation command of the present disclosure;

FIG. 3 is a graph illustrating the repetitive oscillation command;

FIG. 4 is a graph illustrating phase data corresponding to the repetitive oscillation command;

FIG. 5 is a graph equivalent to the phase data corresponding to the repetitive oscillation command;

FIG. 6 is a graph illustrating phase data per servo control cycle;

FIG. 7 is a flowchart illustrating an example of the present disclosure; and

FIG. 8 is a flowchart illustrating another example of the present disclosure.

### PREFERRED MODE FOR CARRYING OUT THE INVENTION

Embodiments of the present disclosure will be described in detail below with reference to the drawings.

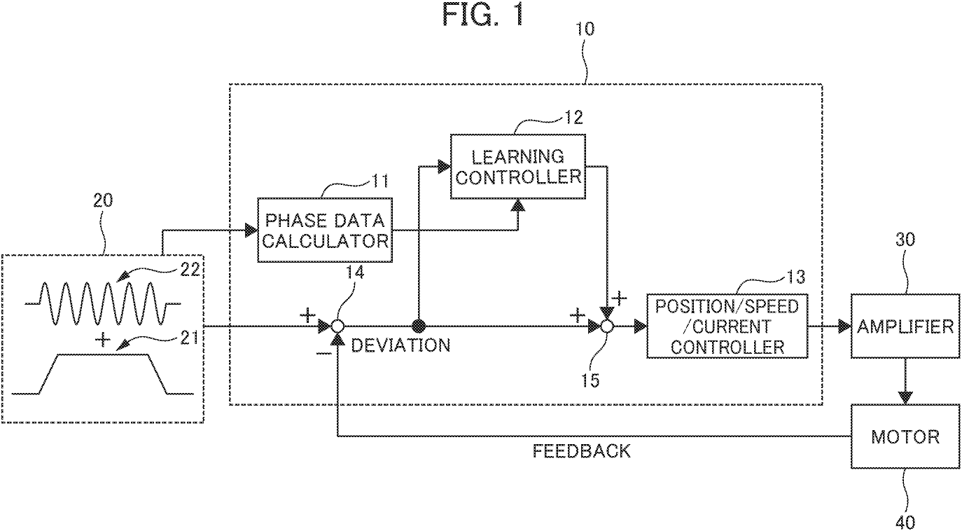

FIG. 1 is a control block diagram of a servo control device of an embodiment of the present disclosure. As shown in FIG. 1, a host controller 20 informs a servo control device 10, which is the servo control device of the embodiment of the present disclosure, of a command signal and data of a cycle of the command signal. Then, learning control is applied by the servo control device 10, an amplifier 30 extends and adjusts the output, and a motor 40 is controlled and driven.

The servo control device 10 includes a phase data calculator 11, a learning controller 12, a position/speed/current controller 13, a first adder 14, and a second adder 15.

The host controller 20 transmits a command signal to the first adder 14 of the servo control device 10, and data of a cycle or frequency of the command signal is fed to the phase data calculator 11. The phase data calculator 11 calculates phase data per servo control cycle and transmits the phase data to the learning controller 12. The calculation of the phase data will be described in detail later. The first adder 14 calculates a deviation between the command signal transmitted from the host controller 20 and a signal fed back from the motor 40, and transmits the deviation to the learning controller 12 and the second adder 15.

The learning controller 12 performs learning control of the deviation between the command signal from the host controller 20 and the signal fed back from the motor 40 calculated by the first adder 14 based on the phase data calculated by the phase data calculator 11.

The learning control calculates a correction amount from an integral deviation up to one cycle before and corrects an inputted command (deviation) to improve followability to a periodical command. The learning control itself is a common technique. Although control by the angle synchronization is employed in the embodiments of the present disclosure, the learning control could not be applied to machining devices with no main shafts, because the learning control requires position data (phase data) based on the frequency of the main shaft. In the embodiments of the present disclosure, the phase data calculator 11 calculates phase data for each servo control cycle and transmits the phase data to the learning controller 12 so that the learning control by the angle synchronization can also be applied to the machining devices with no main shafts.

The second adder 15 adds the deviation between the command signal from the host controller 20 and the signal fed back from the motor 40 calculated by the first adder 14 to the output from the learning controller 12, and outputs the result to the position/speed/current controller 13. The position/speed/current controller 13 calculates a driving voltage of the motor 40 from a position command, a speed command, and a current command that are inputted, and the motor 40 is driven by the output extended and adjusted by the amplifier 30.

The host controller 20 outputs data of a cycle or frequency of a non-repetitive normal move command 21 and a repetitive oscillation command 22 to the servo control device 10. The data of the cycle or frequency of the non-repetitive normal move command 21 and the repetitive oscillation command 22 may be data of the cycle or frequency of the repetitive oscillation command 22 alone, or data of the cycle or frequency of the repetitive oscillation command 22 alone in a command generated by superimposing the repetitive oscillation command 22 on the non-repetitive normal move command 21.

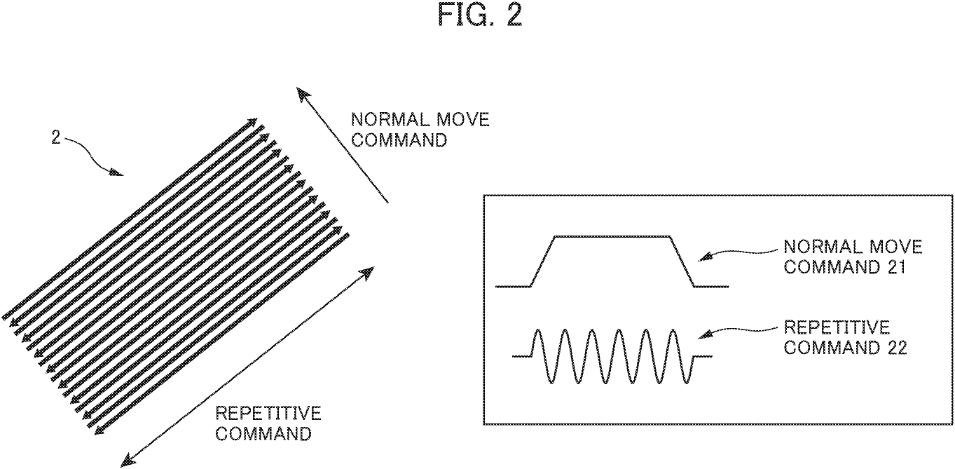

Subsequently, the normal move command and the repetitive oscillation command will be described with reference to FIG. 2. FIG. 2 shows a motion of an object, such as a motion of painting over a certain area (raster motion), in the left part. Specifically, the object is controlled to reciprocate and move in a direction perpendicular to the reciprocating motion every cycle of the reciprocating motion by superimposing the normal move command instructing the object to move in the direction perpendicular to the reciprocating motion on the repetitive oscillation command.

The normal move command is a non-repetitive command, and includes, for example, a trapezoidal command shown as a typical example in the right part of FIG. 2. The repetitive oscillation command is a command instructing the object to repeat the reciprocating motion, and includes, for example, a wavy (e.g., sinusoidal) command shown as a typical- example in the right part of FIG. 2.

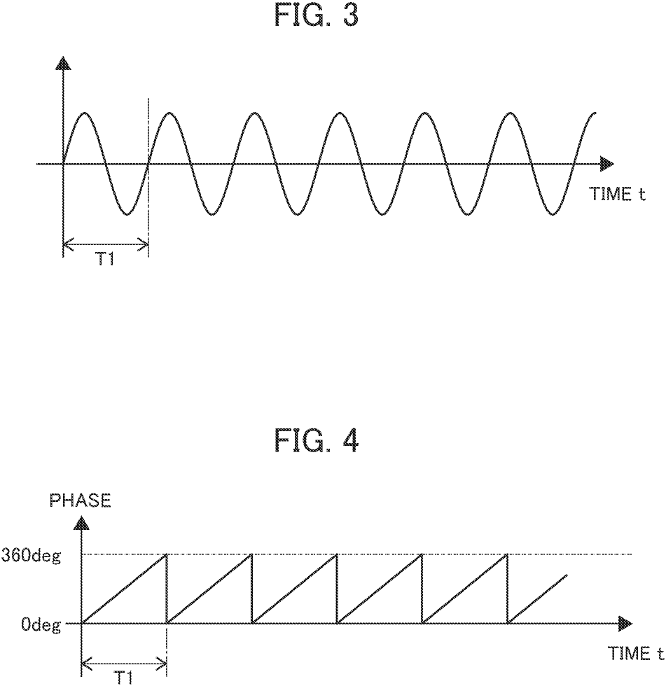

Next, a method of calculating the phase data from the repetitive oscillation command will be described with reference to FIGS. 3 to 6. FIG. 3 shows the repetitive oscillation command. The vertical axis represents a commanded position (distance), and the horizontal axis represents time t elapsed. By the repetitive oscillation command shown in FIG. 3, the commanded position returns to the original position every time T1, i.e., in a cycle T1, because the command is repetitive (reciprocating).

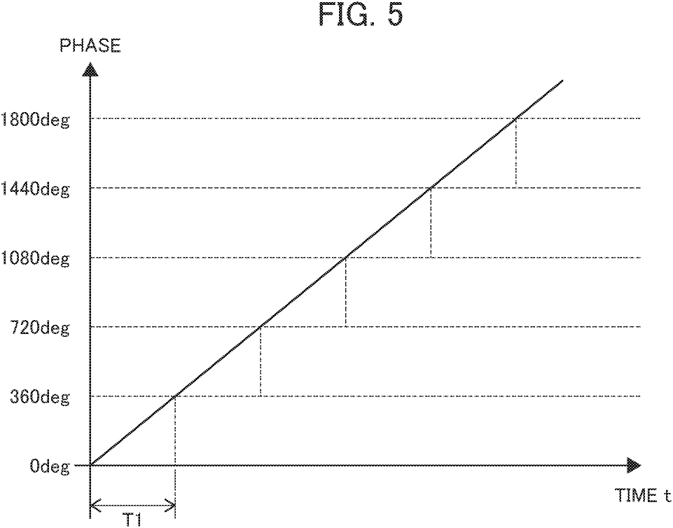

FIG. 4 shows phase data corresponding to the repetitive oscillation command of FIG. 3. The vertical axis represents a phase, and the horizontal axis represents time t elapsed. The phase of the repetitive oscillation command advances by a certain amount every certain period of time, and returns to the original phase every time the phase advances by 360° in a period of cycle T1. Specifically, the phase is proportional to time t in the period of cycle T1. FIG. 4 shows the behavior of the phase.

FIG. 4 shows that the phase returns to the original phase (0°) every time the phase advances by 360° in the period of cycle T1. However, the phase can be greater than 360°. After the phase advanced by 360° in the period of cycle T1, the phase goes beyond 360° as time passes. In this case, the phase is proportional to time t not only in the period of cycle T1, but in the whole period. FIG. 5 shows the behavior of the phase. The vertical axis represents the phase, and the horizontal axis represents time t elapsed.

In the example of FIG. 5, the phase θ is represented as the function θ (t) of time t by the following formula (1), where T1 represents the cycle of the repetitive oscillation command, and t represents time elapsed:

$$\text{θ} \left(\text{t}\right) = 360 \times \left(\text{t} / \text{T1}\right) \qquad \text{[Formula 1]}$$

Suppose that a servo control cycle of the servo control device is Ts, time Ts passes every servo control cycle. Thus, the phase θ(t) after the lapse of a single servo control cycle is calculated by substituting Ts for t in the formula (1) to establish the formula (2):

$$\text{θ} \left(\text{Ts}\right) = 360 \times \left(\text{Ts} / \text{T1}\right) \qquad \text{[Formula 2]}$$

When n servo control cycles (n=1, 2, 3, ...) have passed, the phase θ is represented as the function θ(n) of the cycle n by the formula (3):

$$\text{θ} \left(\text{n}\right) = 360 \times \left(\text{n} ⋅ \text{Ts} / \text{T1}\right) \qquad \text{[Formula 3]}$$

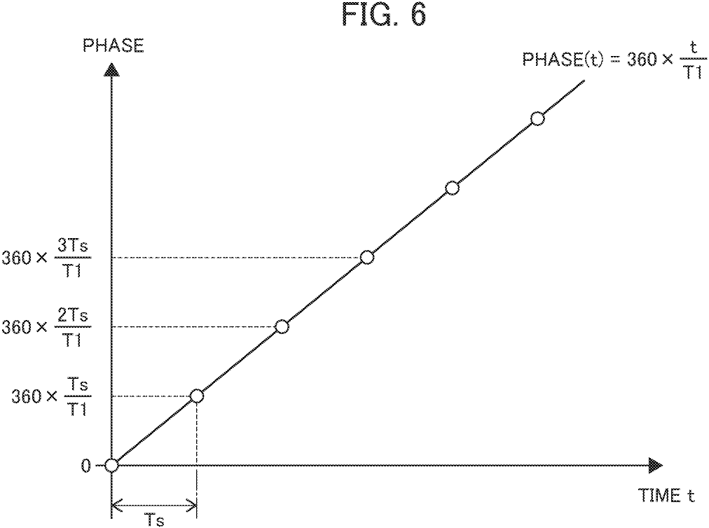

FIG. 6 shows the behavior of the phase. The vertical axis represents the phase, and the horizontal axis represents time t elapsed.

The above description has been made on the assumption that the host controller informs the servo control device of the data of the cycle T1 of the repetitive oscillation command. However, the host controller may inform the servo control device of data of a cycle T2 of the oscillation command alone in the command generated by superimposing the repetitive oscillation command on the non-repetitive normal move command. In such a case, likewise, the phase θ(n) when n servo control cycles (n=1, 2, 3, ...) have passed is represented by the formula (4) :

$$\text{θ} \left(\text{n}\right) = 360 \times \left(\text{n} ⋅ \text{Ts} / \text{T2}\right) \qquad \text{[Formula 4]}$$

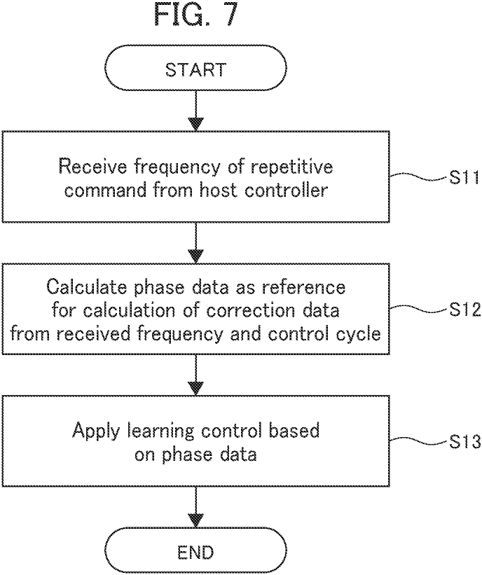

An embodiment of the servo control of the present disclosure will be described below with reference to the flowchart of FIG. 7. First, the servo control device receives the frequency of the repetitive oscillation command from the host controller (Step S11). The received data is inputted to the phase data calculator of the servo control device.

Then, phase data, which is a reference for the calculation of correction data, is calculated from the frequency received in Step S11 and a control cycle (Step S12). As described above, the phase data as the reference for the calculation of the correction data is obtained by the formula θ(n) = 360 × (n·Ts/T1), where T1 represents the cycle of the frequency received, Ts represents the servo control cycle, and n represents the number of servo control cycles elapsed (n = 1, 2, 3, ...).

Finally, learning control is applied based on the phase data calculated in Step S12 (Step S13), and the process ends. In the embodiment of the present disclosure, the phase data as the reference for the calculation of the correction data is calculated from the frequency (cycle) of the repetitive oscillation command informed by the host controller and the control cycle. This allows the learning control to be applied even to the machining device that cannot acquire the phase data from the rotation number of the main shaft.

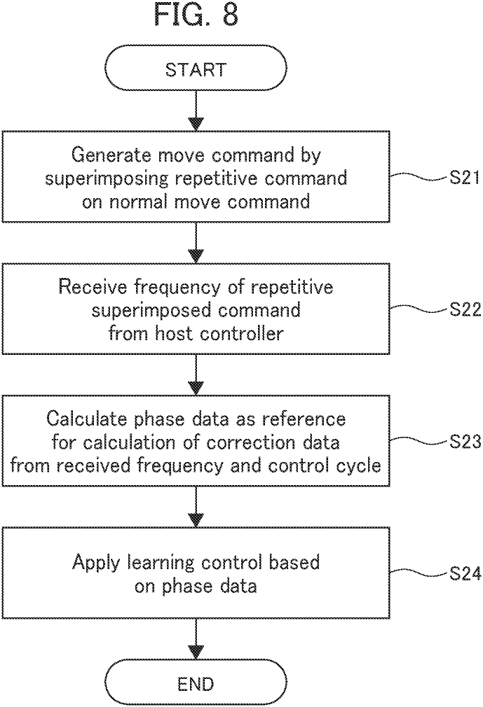

Another embodiment of the servo control of the present disclosure will be described below with reference to the flowchart of FIG. 8. First, the host controller generates a move command by superimposing a repetitive oscillation command on a non-repetitive normal move command (Step S21).

Then, the servo control device receives the frequency of the superimposed command (the frequency of the oscillation command alone in the superimposed command) generated in Step S21 from the host controller (Step S22). The received data is inputted to the phase data calculator of the servo control device.

Then, phase data, which is a reference for the calculation of correction data, is calculated from the frequency received in Step S22 and a control cycle (Step S23). As described above, the phase data as the reference for the calculation of the correction data is obtained by the formula θ(n) = 360 × (n·Ts/T2), where T2 represents the cycle of the frequency of the oscillation command alone in the received superimposed command, Ts represents the servo control cycle, and n represents the number of servo control cycles elapsed (n = 1, 2, 3, ...).

Finally, learning control is applied based on the phase data calculated in Step S23 (Step S24), and the process ends. In the embodiment of the present disclosure, the phase data as the reference for the calculation of the correction data is calculated from the frequency (cycle) of the oscillation command alone in the superimposed command obtained by superimposing the repetitive oscillation command on the normal move command and informed by the host controller. This allows the learning control to be applied even to the machining device that cannot acquire the phase data from the rotation number of the main shaft.

The servo control device of the present disclosure calculates the phase data for each servo control cycle and performs the learning control based on the phase data. Thus, when the machining involving the oscillation motion is performed by the machining device that has no main shaft and cannot acquire the phase data directly from the frequency of the main shaft, the learning control by the angle synchronization can be applied to the device, improving the followability of the device to a periodical command. Consequently, the servo control device of the present disclosure is expected to achieve high precision control of a machine tool with no main shaft.

As for a configuration in which the host controller informs the servo control device of the data of the cycle or frequency of the non-repetitive normal move command and the repetitive oscillation command, the servo control device of the present disclosure can handle the non-repetitive normal move command and the data of the cycle or frequency of the repetitive oscillation command that are informed separately, or the data of the cycle of frequency of the command generated by superimposing the repetitive oscillation command on the normal move command. Thus, it can be said that the servo control device of the present disclosure has increased versatility.

Embodiments have just been described as examples of the present invention. However, the present invention is not limited to those embodiments, but is applicable to other embodiments without deviating from the scope of the present invention.

### EXPLANATION OF REFERENCE NUMERALS

10 Servo control device
11 Phase data calculator
12 Learning controller
13 Position/speed/current controller
14 First adder
15 Second adder
20 Host controller
21 Normal move command
22 Repetitive oscillation command
30 Amplifier
40 Motor

1. A servo control device for controlling a servomotor, the servo control device comprising:
a phase data calculator that calculates, when receiving a repetitive oscillation command alone from a host controller, phase data per servo control cycle of the servo control device from data of a cycle or frequency of the repetitive oscillation command and the servo control cycle of the servo control device, or
calculates, when receiving a superimposed command generated by superimposing the repetitive oscillation command on a non-repetitive normal move command from the host controller, phase data per servo control cycle of the servo control device from data of a cycle or frequency of the repetitive oscillation command alone in the superimposed command and the servo control cycle of the servo control device; and
a learning controller that performs learning control by angle synchronization based on the phase data.

2. The servo control device of claim 1, wherein when receiving the repetitive oscillation command alone from the host controller, the phase data calculator obtains a phase θ (n) per servo control cycle by the following formula (1), where T1 represents the cycle of the repetitive oscillation command, Ts represents the servo control cycle of the servo control device, and n represents the number of servo control cycles elapsed (n = 1, 2, 3, ...).
$$\text{θ} \left(\text{n}\right) = 360 \times \left(\text{n} ⋅ \text{Ts} / \text{T1}\right) \qquad \text{[Formula 1]}$$
.

3. The servo control device of claim 1, wherein when receiving the superimposed command generated by superimposing the repetitive oscillation command on the non-repetitive move command from the host controller, the phase data calculator obtains a phase θ (n) per servo control cycle by the following formula (2), where T2 represents the cycle of the repetitive oscillation command alone in the superimposed command, Ts represents the servo control cycle of the servo control device, and n represents the number of servo control cycles elapsed (n = 1, 2, 3, . . . ) .
$$\text{θ} \left(\text{n}\right) = 360 \times \left(\text{n} ⋅ \text{Ts} / \text{T2}\right) \qquad \text{[Formula 2]}$$
.
